(19) United States
(12) Patent Application Publication
(10) Pub. No.: US 2013/0238842 A1
(43) Pub. Date: Sep. 12, 2013

(54) FLASH STORAGE DEVICE WITH ENHANCED DATA CORRECTION

(71) Applicant: INNODISK CORPORATION, New Taipei City (TW)

(72) Inventor: HSI-HSI WU, NEW TAIPEI CITY (TW)

(73) Assignee: INNODISK CORPORATION, NEW TAIPEI CITY (TW)

(21) Appl. No.: 13/786,503

(22) Filed: Mar. 6, 2013

(30) Foreign Application Priority Data
Mar. 6, 2012 (TW) 101107447

(51) Int. Cl. G06F 12/02

(52) U.S. Cl. CPC G06F 12/0246
USPC 711/103

(57) ABSTRACT

Provided herein is a flash storage device with enhanced data correction, comprising a controller and at least one flash memory comprising a main area and a spare area. The main area comprises a plurality of sectors. The controller selects from the plurality of sectors at least one sector as an auxiliary sector and leaves the other sectors as data sectors for storing data. The spare area is capable of extending the storage capacity with the assistance from the auxiliary sector. The extended spare area is divided into a plurality of spare spaces according to the number of the data sectors, each of the spare spaces corresponding to one of the data sectors to store error correction codes (ECCs) for data verification. Thereby, the spare area is extended by sacrificing parts of the space of the main area so as to store lengthened error correction codes and enhance data correction.

### CROSS-REFERENCES TO RELATED APPLICATIONS

This application claims the benefit of Taiwan, R.O.C. Patent Application No. 101107447 filed on Mar. 6, 2012, the disclosures of which is incorporated by reference herein in their entirety.

1. Field of the Invention

The present invention generally relates to a flash storage device and, r more particularly, to a flash storage device with enhanced data correction to increase corrected error bit capability.

2. Background of the Invention

With the rapidly developing semiconductor processing technologies, the flash storage device has higher storage capacity and has been widely used for data backup.

Meanwhile, the possibility of generating data errors increases with higher storage capacity. Accordingly, it has been crucial for storage manufacturers to improve the reliability of flash storage devices.

Referring to FIG. 1A for a data structure diagram of a flash memory in a conventional flash storage device, the data structure of the flash memory 10 will be described by the page.

The data structure of the flash memory 10 comprises a main area 11 and a spare area 13. The main area 11 comprises a plurality of data sectors 111. Taking an 8-KB (kilobyte) page for example, there are 8 data sectors (1˜N; N=8) 111 in the main area 11 if each of the data sectors 111 is designed to be 1 KB in size. The storage capacity of the spare area 13 is divided into a plurality of spare spaces (spare space) 131 according to the number of data sectors 111, for example, 8.

Further referring to FIG. 1B, each of the data sectors 111 corresponds to a spare space 131. For example, a 1-KB data sector 111 is allocated with a spare space 131 having a length La1 of 32 bytes according to the current storage manufacturers, while the spare area 13 has a length L1 of 256 (La1×8) bytes. The spare spaces 131 are used to store error correction codes (ECCs). Moreover, ECCs are generated by many forms of algorithms such as BCH codes, Reed-Muller codes, Reed-Solomon code, etc. Data verification can be achieved using ECCs so that the data stored in the data sectors 111 can be fault-tolerantly corrected to improve data reliability.

In the early days for flash memory storage, each cell in the flash memory with single level cells (SLC) had two possible states, 0 and 1. In order to enlarge the storage capacity and accelerate the accessing for flash memory storage, each cell in the flash memory with multi level cells (MLC) has been developed to have at least four states, i.e., 00, 01, 10, 11. However, the MLC flash memories are much more likely to cause data errors than the SLC flash memories. Therefore, the ECCs have to be lengthened with response to enhanced data correction of the flash storage device.

Taking the algorithm for BCH codes for example, the currently available spare spaces 131 having the length La1 of 32 bytes are sufficient because only 28 bytes are required to store the ECCs for 16 byte data correction (BCH 16) in the 1 KB data sectors 111. However, to further improve data reliability in the data sectors 111, the ECCs are required to be lengthened for enhanced data correction. For example, if BCH 40 is adopted, the spare spaces 131 having the length La1 of 32 bytes will be insufficient because it tales about 70 bytes for BCH 40.

Accordingly, data correction of the flash memory relies on the length of the spare spaces 131, which is specified by the storage manufacturer and cannot be extended by the user. As a result, data reliability of the flash memory cannot be effectively improved.

### SUMMARY OF THE INVENTION

It is one object of the present invention to provide a flash storage device comprising at least one flash memory. The flash memory comprises a main area for data storage and a spare area for storing verified data. The flash storage device transfers part of the storage capacity from the main area to the spare area so as to extend the spare area. Thereby, the spare area extended by sacrificing parts of the space of the main area so as to store lengthened error correction codes and enhance data correction.

It is another object of he present invention to provide a flash storage device, wherein plurality of flash memories with multiple channels are integrated in a flash memory module with a single channel so as to enhance the efficiency in the use of storage space.

To achieve above objects, the present invention provides a flash storage device with enhanced data correction, comprising: a controller; and at least one flash memory, comprising at least one flash page, said flash page comprising: a main area comprising a plurality of sectors, wherein the controller selects from the plurality of sectors at least one sector as an auxiliary sector and leaves the other sectors as data sectors for storing data; and a spare area capable of extending the storage capacity with the assistance from the auxiliary sector, herein the extended spare area is divided into a plurality of spare spaces according to the number of the data sectors, each of the spare spaces corresponding to one of the data sectors to store error correction codes (ECCs) for data verification.

The present invention further provides a flash storage device with enhanced data correction,comprising: a controller; and at least one flash memory module integrating a plurality of flash module communicating with the controller through a channel, the flash memory module comprising at least one flash page, said flash page comprising: a main area comprising a plurality of sectors, wherein the controller selects from the plurality of sectors at least one sector as an auxiliary sector and leaves the other sectors as data sectors for storing data; and a spare area capable of extending the storage capacity with the assistance from the auxiliary sector, wherein the extended spare area is divided into a plurality of spare spaces according to the number of the data sectors, each of the spare spaces corresponding to one of the data sectors to store error correction codes (ECCs).

In one embodiment of the present invention, wherein the controller performs fault-tolerant data correction by an algorithm for BCH codes. Reed-Muller codes, Reed-Solomon codes or a capable of realizing the ECCs algorithm.

### BRIEF DESCRIPTION OF THE DRAWINGS

The objects and spirits of the embodiments of the present invention will be readily understood by the accompanying drawings and detailed descriptions, where

FIG. 1A is a data structure diagram of a flash memory a conventional flash storage device;

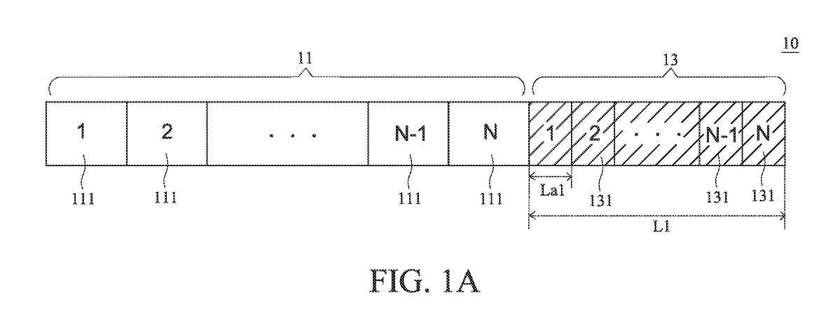

FIG. 1B is a data structure of a conventional data sector and a spare space allocated thereof;

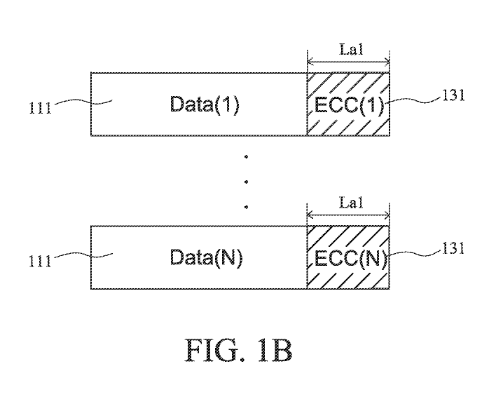

FIG. 2 is a circuit diagram of a flash storage device with enhanced data correction according to one preferred embodiment of the present invention;

FIG. 3A is a data structure diagram of a flash memory according to one preferred embodiment of the present invention;

FIG. 3B is a data structure diagram of a data sector and a spare space allocated thereof according to one preferred embodiment of the present invention;

FIG. 4 is a circuit diagram of a flash storage device with enhanced data convection according to another embodiment of the present invention;

FIG. 5A is a data structure diagram of a flash memory module according to one embodiment of the present invention; and

FIG. 5B is a data structure diagram of a data sector and a spare space allocated therof according to one embodiment of the present invention.

### DETAILED DESCRIPTION OF THE PREFERRED EMBODIMENTS

The present invention may be exemplified but not limited by various embodiments as described hereinafter.

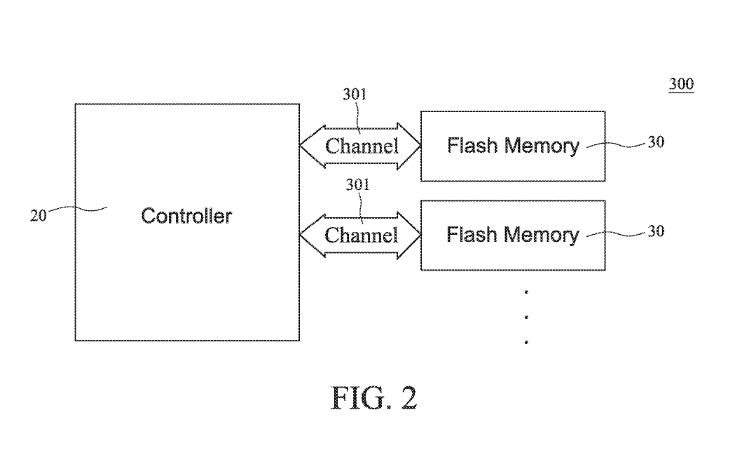

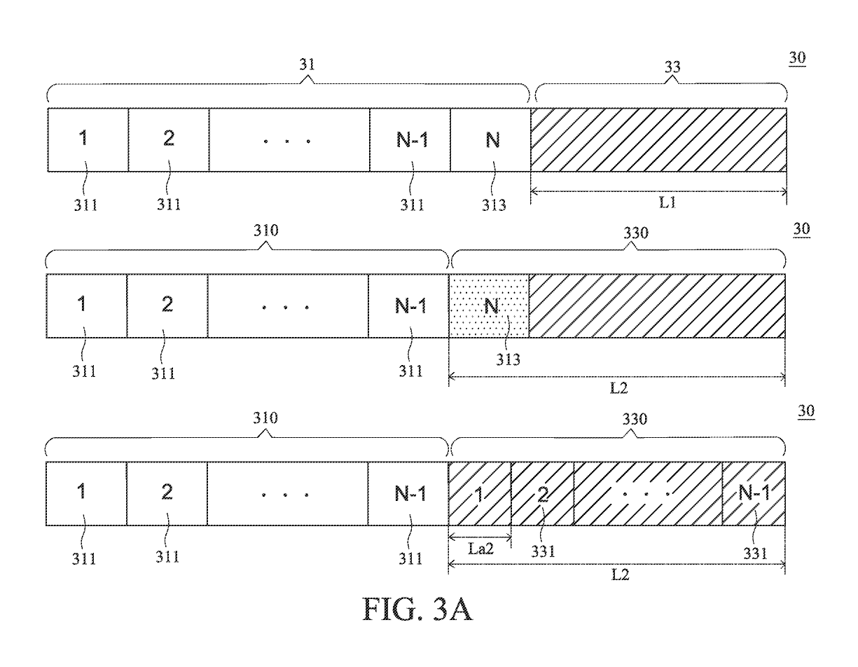

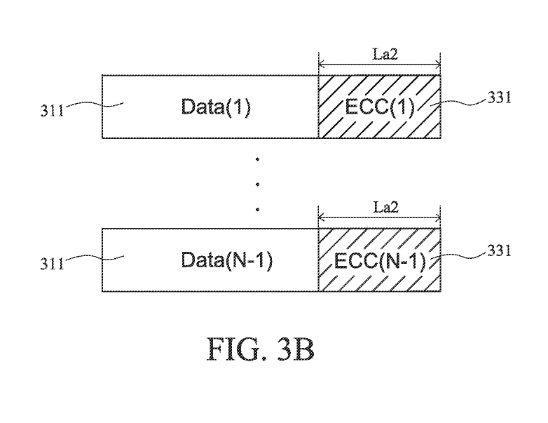

Please refer to FIG. 2 for a circuit diagram of a flash storage device with enhanced data correction according to one preferred embodiment of the present invention and FIG. 3A and FIG. 3B for a data structure diagram of a flash memory and a data structure diagram of a data sector and a spare space allocated thereof, respectively, according to one preferred embodiment of the present invention.

In one preferred embodiment of the present invention, the flash storage device 300 comprises a controller 20 and at least one flash memory 30. Each of the flash memories 30 communicates with the controller 20 through a respective channel 301. In the present specification, the data structure of the flash memory 30 is described by the page. The page size is 1, 2, 4, 8 or 16 kilobytes (KB).

The flash page data structure of the flash memory 30 comprises a main area 31 and a spare area 33. The main area 31 comprises a plurality of sectors for sub-pages) 311, 313. In the present embodiment, an 8-KB page is taken for example. The main area 31 comprises 8 sectors (1˜N; N=8) 311, 313 if each of the sectors 311, 313 has the length of 1 KB. Usually, the storage manufacturers provide a spare area 33 having the length L1 of 256 bytes (32 bytes×8). The storage capacity of the spare area 33 depends on the cost and specifications of the storage manufacturers.

In the present invention, the controller 20 selects ‘from the plurality of sectors 311, 313 at least one sector 313 as an auxiliary sector and leaves the other sectors 311 as data sectors for storing data. The auxiliary sector 313 assists to extend the storage capacity of the spare area 33.

In the present embodiment, if the sector 313 is selected as the auxiliary sector, the other seven sectors 311 are left as data sectors. The auxiliary sector 313 assists to extend the storage capacity of the spare area 33. In other words, the length L1 of the spare area 330 is extended to the length L2, for example, from 256 bytes to 1280 (i.e., 256+1024) bytes.

The extended spare area 330 is divided into a plurality of spare spaces 331 according to the number of the data sectors 311, for example, 7. Each of the spare spaces 331 corresponding to one of the data sectors 311 has the length La2 of 182 bytes (i.e., 1280+7) to store error correction codes (ECCs) for data verification. In the present invention embodiment, there are numerous algorithms for generating ECCs, such as the algorithm for BCH codes, Reed-Muller codes, Reed-Solomon codes or a capable of realizing ECCs.

Accordingly, each of the extended spare spaces 331 provides 182 bytes for storing ECCs. If the algorithm for BCH codes is adopted, the spare spaces 331 having the length of 182 bytes are sufficient to store the ECCs for data correction (BCH 40). For example, 70 bytes are required for BCH 40. More particularly, the flash storage device 300 of the present invention provides superior data correction to conventional flash storage devices.

Therefore, in the present invention, the flash storage device 300 is capable of transferring part of the data space of the main area 310 to the storage capacity of the spare area 330. As a result, the storage capacity of the spare area 330 is extended. In other words, the spare spaces 331 are extended to store lengthened ECCs for enhanced data correction as well as improved data reliability by sacrificing parts of the data space of the main area 310, for example, ⅛ sector.

Moreover, even though the flash memory 30 of the present embodiment is exemplified by 8-KB page and 1-KB sub-pages (such as sectors 311/313), pages with other sizes (such as 1, 2, 4 or 16 KB) and sub-pages (sectors 311/313) with 256 bytes may also be used in other embodiments of the present invention. Furthermore, in another embodiment of the present invention, more than two sectors 313 may be used as auxiliary sectors so as to further extend the spare space 331 for storing lengthened ECCs to enhance data correction.

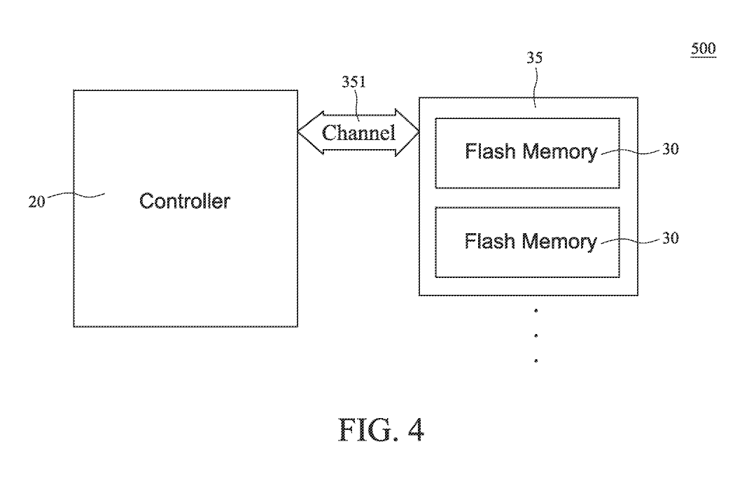

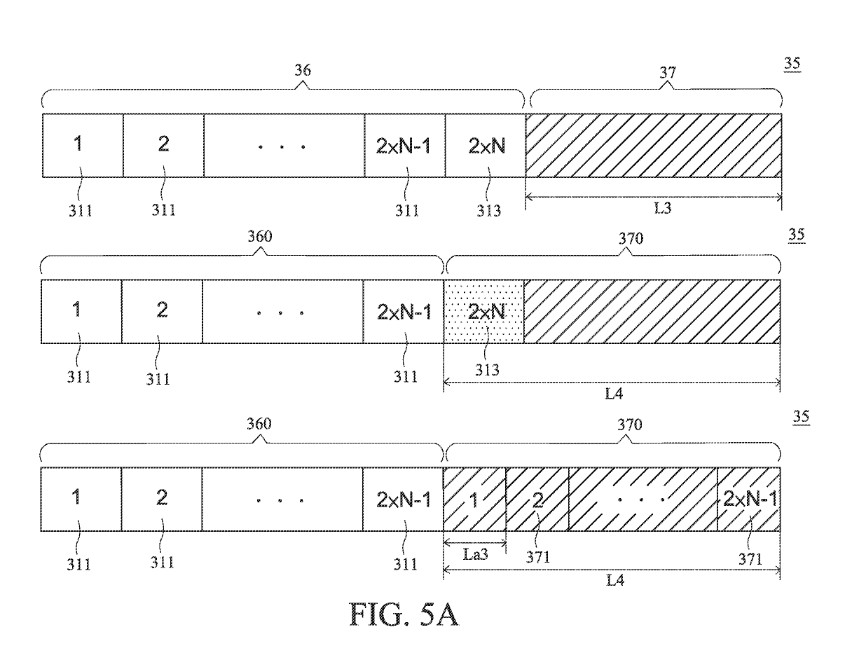

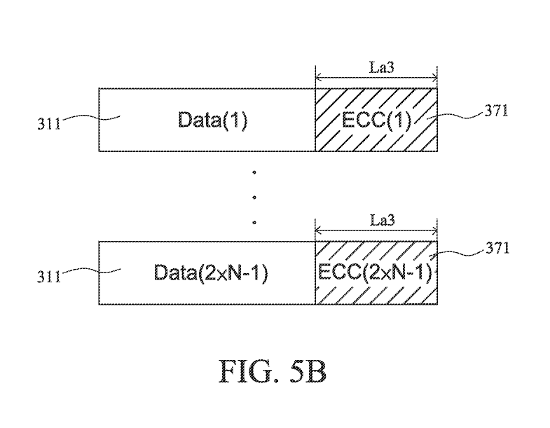

Please refer to FIG. 4 for a circuit diagram of a flash storage device with enhanced data correction according to another embodiment of the present invention and FIG. 5A and FIG. 5B for a data structure diagram of a flash memory module and a data structure diagram of a data sector and a spare space allocated thereof, respectively, according to one preferred embodiment of the present invention.

In the flash storage device 300 of the previous embodiment, each of the flash memories 30 communicates with the controller 20 through a respective channel 301. However, in the flash storage device 500 of the present embodiment, a plurality of flash memories 30 with multiple channels 301 are integrated in a flash memory module 35 with a single channel 351. For example, two flash memories 30 with 8-bit channels 301 are integrated in a flash memory module 35 with a 16-bit channel 351.

In the present specification, the data structure of the flash memory 30 is described by the page. The page size is 8 kilobytes (KB) and each of the sectors 311, 313 has the length of 1 KB.

The flash page data structure of the flash memory module 35 comprises a main area 36 and a spare area 37. Since the flash memory module 35 is integrated by two flash memories 30 so that the main area 36 comprises 16 sectors (1˜2×N; N=8) 311, 313 and the length L3 of the spare area 37 is 512 bytes (32 bytes×16).

Similarly, the controller 20 selects from the plurality of sectors 311, 313 at least one sector 313 as an auxiliary sector and leaves the other sectors 311 as data sectors for storing data. The auxiliary sector 313 assists to extend the storage capacity of the spare area 37.

In the present embodiment, if the sector 313 is selected as the auxiliary sector, the other 15 sectors 311 are left as data sectors. The auxiliary sector 313 assists to extend the storage capacity of the spare area 37. In other words, the length L3 of the spare area 370 is extended to the length L4, for example, from 512 bytes to 1536 (i.e., 512+1024) bytes.

The extended spare area 370 is divided into a plurality of spare spaces 371 according to the number of the data sectors 311, for example, 15. Each of the spare spaces 371 corresponding to one of the data sectors 311 has the length La1 of 102 (i.e., 1536÷15) bytes to store error correction codes (ECCs).

Each of the extended spare spaces 371 provides 102 bytes for storing ECCs. If the algorithm for BCH codes is adopted, the spare spaces 371 having the length of 102 bytes are sufficient to store the ECCs for data correction (BCH 40). For example, 70 bytes are required for BCH 40.

As previously stated, two flash memories 30 with two channels 301 will respective sacrifice ⅛ spaces (e.g. ⅛ sectors) of the main area 310 to extend the storage capacity of the spare area 330 if they are not integrated. An integrated flash memory module 35 with a single channel 351 will only sacrifice 1/16 spaces (e.g. 1/16 sectors) of the main area 360 to extend the storage capacity of the spare area 370. In other words, the integrated flash memory module 35 may be more 3/16 data space to store data than the two flash memories 30. Therefore, if more flash memories 30 with multiple channels 301 are integrated in a flash memory module 35 with a single channel 351, less storage capacity will be sacrificed and more storage capacity can be saved data for the flash storage device 500.

According, in the present embodiment, the flash storage device 500 with integrated flash memories provides superior data correction without sacrificing too much storage capacity.

The foregoing description is merely one embodiment of the present invention and not considered as restrictive. All equivalent variations and modifications in shape, structure, feature, and spirit in accordance with the appended claims may be made without in any way from the scope of the invention.

What is claimed is:

1. A flash storage device with enhanced data correction, comprising:
a controller; and
at least one flash memory, comprising at least one flash page, said flash page comprising:
a main area comprising a plurality of sectors, wherein said controller selects from said plurality of sectors at least one sector as an auxiliary sector and leaves the other sectors as data sectors for storing data; and
a spare area capable of extending the storage capacity with the assistance from said auxiliary sector, wherein said extended spare area is divided into a plurality of spare spaces according to the number of said data sectors, each of said spare spaces corresponding to one of said data sectors to store error correction codes (ECCs) for data verification.

2. The flash storage device as recited in claim 1, wherein said controller performs fault-tolerant data correction by an algorithm for BCH codes, Reed-Muller codes, Reed-Solomon codes or a capable of realizing said ECCs algorithm.

3. A flash storage device with enhanced data correction, comprising:
a controller; and
at least one flash memory module integrating a plurality of flash memories and communicating with said controller through a channel, said flash memory module comprising at least one flash page, said flash page comprising:
a main area comprising a plurality of sectors, wherein said controller selects from said plurality of sectors at least one sector as an auxiliary sector and leaves the other sectors as data sectors for storing data; and
a spare area capable of extending the storage capacity with the assistance from said auxiliary sector, wherein said extended spare area is divided into a plurality of spare spaces according to the number of said data sectors, each of said spare spaces corresponding to of said data sectors to store error correction codes (ECCs).

4. The flash storage device as recited in claim 3, wherein said controller performs fault-tolerant data correction by an algorithm for BCH codes, Reed-Muller codes, Reed-Solomon codes or a capable of realizing said ECCs algorithm.
